(19) United States
(12) Patent Application Publication
(10) Pub. No.: US 2026/0096512 A1
(43) Pub. Date: Apr. 9, 2026

(54) OUTLET ASSEMBLY FOR A ROW UNIT OF AN AGRICULTURAL HARVESTER

(71) Applicant: CNH Industrial America LLC, New Holland, PA (US)

(72) Inventors: Kyle Lester Lensch, Bennett, IA (US); Timothy Alan Meeks, Donahue, IA (US); Daniel Krieg, Anamosa, IA (US); Eric Underwood, McCune, KS (US)

(21) Appl. No.: 18/905,259

(22) Filed: Oct. 3, 2024

(51) Int. Cl. A01D 46/08; A01D 46/10; A01D 67/00

(52) U.S. Cl. CPC A01D 46/081; A01D 46/10; A01D 67/00

(57) ABSTRACT

An outlet assembly for a row unit of an agricultural harvester includes an input portion configured to be coupled to a frame of the row unit. The input portion includes an inlet configured to receive agricultural product and an outlet configured to expel the agricultural product. The outlet assembly also includes an output portion having an inlet configured to receive the agricultural product from the outlet of the input portion and an outlet configured to direct the agricultural product into a duct of an air-assisted conveying system. The output portion and the input portion are at least selectively coupled to one another and configured to at least selectively rotate relative to one another.

### BACKGROUND

The present disclosure relates generally to an outlet assembly for a row unit of an agricultural harvester.

Agricultural harvesters are used to harvest agricultural products (e.g., cotton or other natural material(s)). For example, an agricultural harvester may include a header having row units configured to harvest the agricultural product from a field. The agricultural harvester may also include an air-assisted conveying system configured to move the agricultural product from the row units to an accumulator. The agricultural product may then be fed into a baler via a conveying system. The baler may compress the agricultural product into a package to facilitate storage, transport, and handling of the agricultural product. For example, a round baler may compress the agricultural product into a round bale within a baling chamber, such that the round bale has a desired size and density. After forming the bale, the bale may be wrapped with a bale wrap to secure the agricultural product within the bale and to generally maintain the shape of the bale.

### BRIEF DESCRIPTION

In certain embodiments, an outlet assembly for a row unit of an agricultural harvester includes an input portion configured to be coupled to a frame of the row unit. The input portion includes an inlet configured to receive agricultural product and an outlet configured to expel the agricultural product. The outlet assembly also includes an output portion having an inlet configured to receive the agricultural product from the outlet of the input portion and an outlet configured to direct the agricultural product into a duct of an air-assisted conveying system. The output portion and the input portion are at least selectively coupled to one another and configured to at least selectively rotate relative to one another.

### BRIEF DESCRIPTION OF THE DRAWINGS

These and other features, aspects, and advantages of the present disclosure will become better understood when the following detailed description is read with reference to the accompanying drawings in which like characters represent like parts throughout the drawings, wherein:

FIG. 1 is a side view of an embodiment of an agricultural harvester having a header;

FIG. 2 is a schematic view of an embodiment of an agricultural product transport assembly and an embodiment of a baler that may be employed within the agricultural harvester of FIG. 1;

FIG. 3 is a perspective view of an embodiment of a header that may be employed within the agricultural harvester of FIG. 1 and an embodiment of an air-assisted conveying system that may be employed within the agricultural product transport assembly of FIG. 2;

FIG. 4 is a perspective view of an embodiment of an outlet assembly that may be employed within a row unit of the header of FIG. 3 and a duct that may be employed within the air-assisted conveying system of FIG. 3;

FIG. 5 is a cross-sectional view of the outlet assembly of FIG. 4;

FIG. 6 is a cross-sectional view of the outlet assembly of FIG. 4, including an adapter; and

FIG. 7 is a cross-sectional view of a portion of another embodiment of an outlet assembly that may be employed within a row unit of the header of FIG. 3.

### DETAILED DESCRIPTION

One or more specific embodiments of the present disclosure will be described below. In an effort to provide a concise description of these embodiments, all features of an actual implementation may not be described in the specification. It should be appreciated that in the development of any such actual implementation, as in any engineering or design project, numerous implementation-specific decisions must be made to achieve the developers’ specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present disclosure, the articles “a,” “an,” “the,” and “said” are intended to mean that there are one or more of the elements. The terms “comprising,” “including,” and “having” are intended to be inclusive and mean that there may be additional elements other than the listed elements. Any examples of operating parameters and/or environmental conditions are not exclusive of other parameters/conditions of the disclosed embodiments.

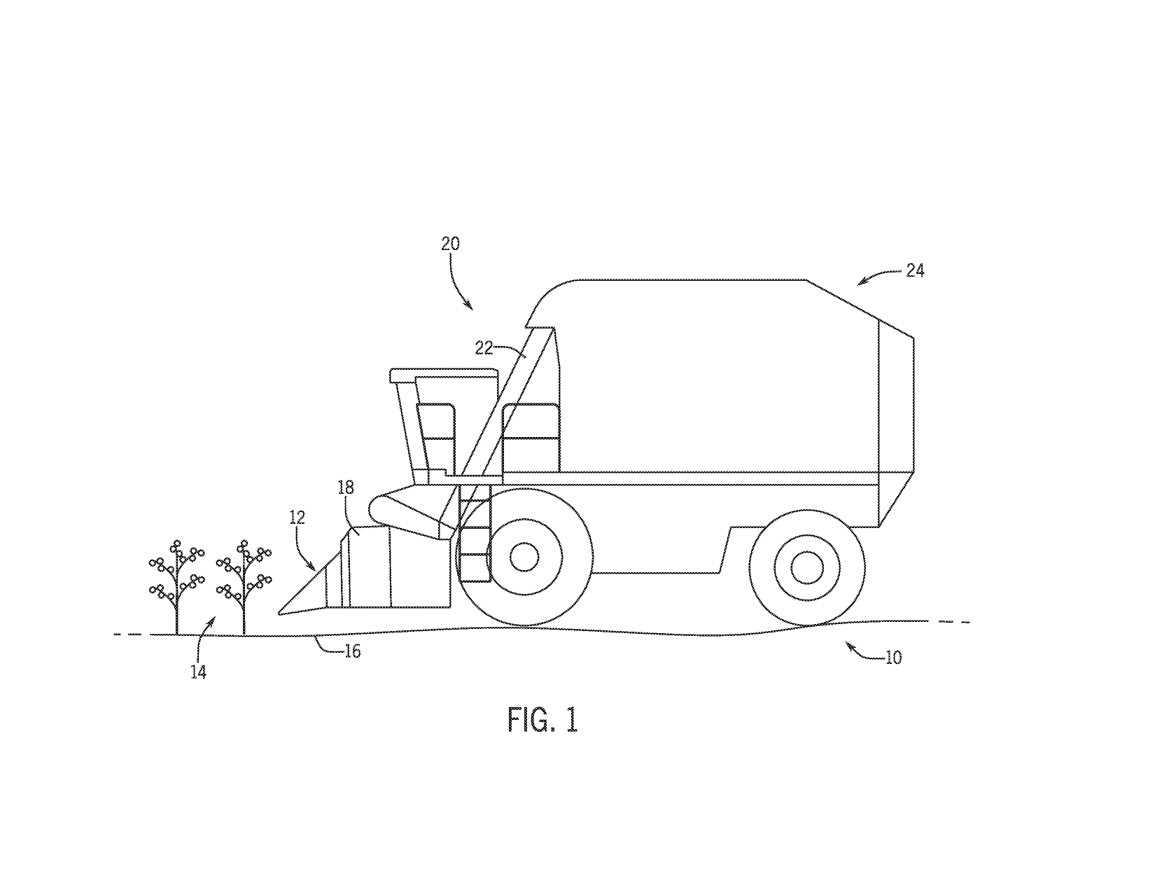

FIG. 1 is a side view of an embodiment of an agricultural harvester 10 having a header 12. The agricultural harvester 10 is configured to harvest agricultural product 14 (e.g., seed cotton) from a field 16 and to form the agricultural product 14 into bales (e.g., agricultural bales). In the illustrated embodiment, the header 12 of the agricultural harvester 10 includes multiple row units 18 distributed across the width of the header 12. Each row unit 18 is configured to harvest a respective row of the agricultural product 14 from the field 16. Additionally, the agricultural harvester 10 includes an agricultural product transport assembly 20 having an air-assisted conveying system 22 configured to move the agricultural product 14 from the row units 18 of the header 12 to an accumulator of the agricultural product transport assembly 20. The agricultural product transport assembly 20 also includes a conveying system configured to convey the agricultural product 14 from the accumulator into a baler 24. The baler 24 is supported by and/or mounted within or on a chassis of the agricultural harvester 10. The baler 24 may form the agricultural product 14 into round bales. However, in other embodiments, the baler 24 of the agricultural harvester 10 may form the agricultural product into square bales, polygonal bales, or bales of other suitable shape(s). After forming the agricultural product 14 into a bale, a bale wrapping system of the agricultural harvester 10 wraps the bale with a bale wrap to secure the agricultural product 14 within the bale and to generally maintain a shape of the bale.

In certain embodiments, each row unit 18 includes two rotors positioned on opposite sides of a central path through the row unit 18 or on the same side of the central path. Each rotor includes multiple spindles (e.g., barbed spindles) extending into the central path, and the spindles are configured to engage a crop (e.g., cotton plant) along a substantial portion of the height of the crop. During operation of the agricultural harvester 10, the central path of the row unit 18 is aligned with a row of crops. Accordingly, as the agricultural harvester 10 traverses the field 16, the row unit 18 receives each crop of the row, and the spindles of the rotors engage the crop. The rotors are driven to rotate, such that engagement of the spindles with the crop separates the agricultural product (e.g., seed cotton) from the plant stalk (e.g., the crop after the agricultural product is removed). The agricultural product removed from the crop collects on the spindles, and the agricultural product is removed from the spindles by doffers. Each doffer directs the agricultural product to a respective conveying chamber, and airflow generated by the air-assisted conveying system 22 moves the agricultural product from the conveying chambers to the accumulator via a duct of the air-assisted conveying system 22. After the agricultural product is removed from the spindles of each rotor, the spindles pass through a moistener column assembly to remove buildup of crop liquids (e.g., sap, etc.) from the spindles. As the rotors continue to rotate, the spindles engage a subsequent crop at the central path, while the plant stalk remains attached to the ground.

In certain embodiments, at least one row unit 18 of the header 12 (e.g., each row unit 18 of the header 12) includes an outlet assembly configured to facilitate lateral movement of the row unit 18 along a chassis of the header 12. In such embodiments, the outlet assembly includes an input portion coupled to a frame of the row unit 18. The input portion includes an inlet configured to receive the agricultural product (e.g., from the conveying chambers of the row unit) and an outlet configured to expel the agricultural product. The outlet assembly also includes an output portion having an inlet configured to receive the agricultural product from the outlet of the input portion and an outlet configured to direct the agricultural product into a respective duct of the air-assisted conveying system 22. The output portion and the input portion are at least selectively coupled to one another and configured to at least selectively rotate relative to one another. As a result, the respective duct is at least selectively rotatable relative to the row unit, thereby enabling the row unit 18 to move with respect to a lateral axis of the header 12. Therefore, the lateral spacing between row units may be adjusted without removing and replacing the outlet assemblies, thereby substantially reducing the duration associated with adjusting the lateral spacing between the row units (e.g., as compared to a configuration in which the row units have non-rotating outlet assemblies particularly configured for a single row spacing, and changing the lateral spacing between the row units involves replacing the outlet assemblies with different outlet assemblies particularly configured for the different row spacing).

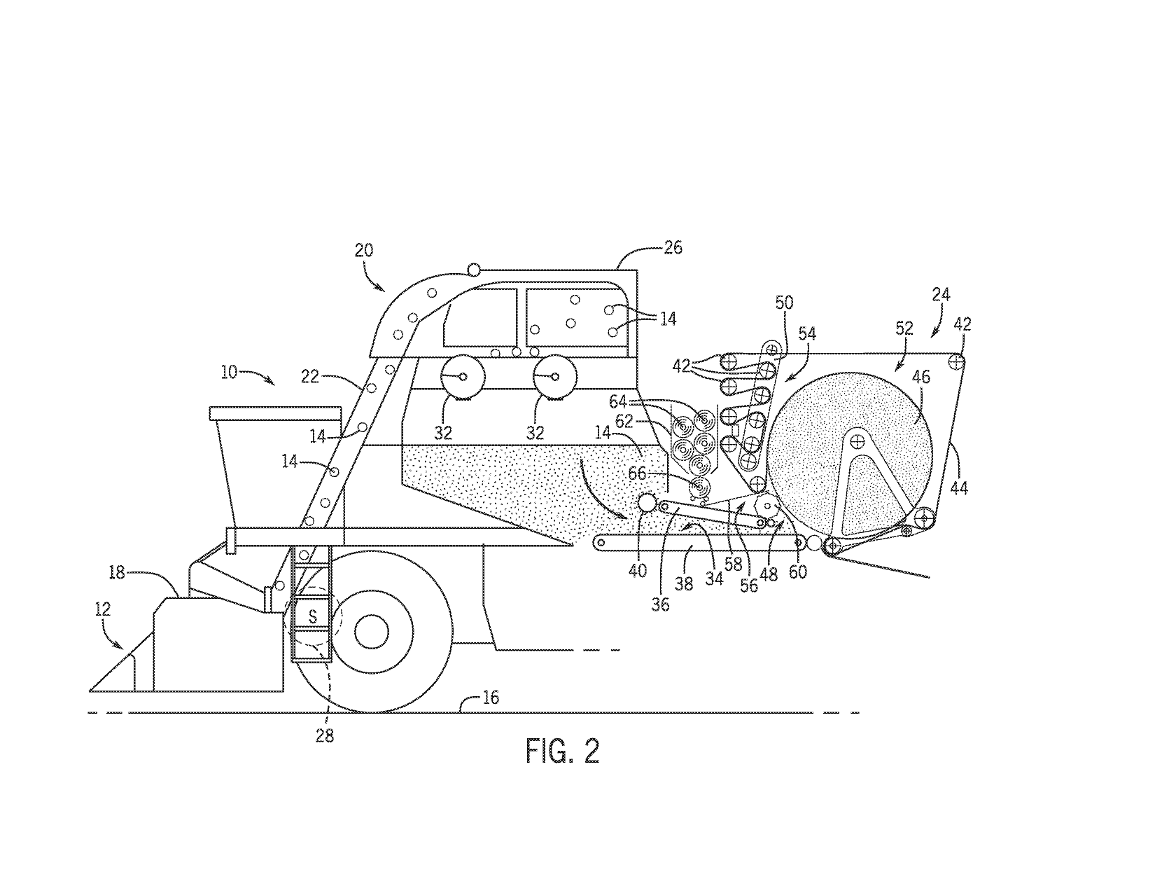

FIG. 2 is a schematic view of an embodiment of an agricultural product transport assembly 20 and an embodiment of a baler 24 that may be employed within the agricultural harvester 10 of FIG. 1. As previously discussed, the header 12 of the agricultural harvester 10 includes row units 18 configured to harvest the agricultural product 14 (e.g., seed cotton) from the field. Furthermore, the air-assisted conveying system 22 is configured to move the agricultural product 14 from the row units 18 of the header 12 to the accumulator 26. In the illustrated embodiment, the air-assisted conveying system 22 includes a conveying air source 28 configured to output a conveying air flow through ducts 30. Each duct 30 receives the agricultural product 14 (e.g., seed cotton) from a respective row unit 18 of the header 12, and the conveying air flow output by the conveying air source 28 drives the agricultural product to move through the ducts 30 from the header 12 to the accumulator 26. In the illustrated embodiment, the agricultural product transport assembly 20 includes augers 32 configured to distribute the agricultural product 14 (e.g., seed cotton) laterally across the accumulator 26 (e.g., crosswise to the downward movement of the agricultural product through the accumulator). In the illustrated embodiment, the agricultural product transport assembly 20 includes two augers 32. However, in other embodiments, the agricultural product transport assembly may include more or fewer augers (e.g., 0, 1, 3, 4, or more).

In the illustrated embodiment, the conveying system 34 of the agricultural product transport system 20 includes a first belt (e.g., belt) 36 configured to move the agricultural product 14 from the accumulator 26 to the baler 24. The first belt 36 is configured to rotate in a first rotational direction to move an agricultural product engaging surface of the first belt 36 toward the baler 24. Furthermore, in the illustrated embodiment, the conveying system 34 includes a second belt 38 positioned on an opposite side of the agricultural product 14 from the first belt 36, and the second belt 38 is configured to cooperate with the first belt 36 to move the agricultural product 14 from the accumulator 26 to the baler 24. Furthermore, in the illustrated embodiment, the conveying system 34 includes an agitation roller 40 positioned upstream of the first belt 36. The agitation roller 40 is configured to agitate the agricultural product 14 entering the pair of opposing belts, thereby enhancing the uniformity of the distribution of the agricultural product passing through the pair of opposing belts.

In the illustrated embodiment, the baler 24 includes multiple rollers 42 that support and/or drive rotation of one or more belts 44. For example, one or more rollers 42 engage the belt(s) 44, which enable the belt(s) 44 to move along the pathway defined by the rollers 42 and the bale 46. One or more rollers 42 are driven to rotate via a belt drive system (e.g., including electric motor(s), hydraulic motor(s), pneumatic motor(s), etc.). The belt(s) 44 circulate around the pathway defined by the rollers 42 and the bale 46. Movement of the belt(s) 44 captures agricultural product 14 from the conveying system 34 and draws the agricultural product 14 into a cavity 48, where the agricultural product 14 is gradually built up to form the bale 46.

In the illustrated embodiment, the baler 24 includes a tension arm 50 configured to establish tension within the belt(s) 44. As the agricultural product 14 builds within the cavity 48, the agricultural product 14 applies a force to the belt(s) 44 that urges a first portion 52 of the belt(s) 44 surrounding the bale 46 to expand. Concurrently, the size of a second portion 54 (e.g., serpentine portion) of the belt(s) 44 is reduced. Accordingly, the second portion 54 of the belt(s) 44 provides the increasing belt length for the expanding first portion 52. In the illustrated embodiment, the second portion 54 of the belt(s) 44 is established by fixed rollers 42 (e.g., rollers fixed to a housing/frame of the baler 24) and rollers 42 coupled to the tension arm 50, which is pivotable relative to the fixed rollers 42 (e.g., relative to the housing/frame of the baler 24). Accordingly, as the agricultural product 14 builds within the cavity 48, the tension arm 50 is driven to rotate, thereby reducing the size of the second portion 54 and enabling the first portion 52 to expand.

Once the bale 46 reaches a desired size, a bale wrapping system 56 wraps the bale 46 with a bale wrap 58 to secure the agricultural product within the bale 46 and to generally maintain a shape of the bale 46, such as the round shape in the illustrated embodiment. In other embodiments, the shape of the bale may be rectangular, polygonal, or another suitable shape. The bale wrap 58 may be fed into contact with the bale 46 using one or more rollers and/or one or more belts of a bale wrap feeding assembly. The roller(s) and/or the belt(s) drive the bale wrap 58 toward a starter roller 60. The starter roller 60 is configured to rotate to drive the bale wrap 58 into contact with the bale 46. The bale wrap 58 is captured between the bale 46 and the belt(s) 44. Accordingly, rotation of the bale 46 draws the bale wrap 58 around the bale 46, thereby wrapping the bale 46. After the bale 46 is wrapped, the bale 46 is ejected from the baler 24, and the process of forming a subsequent bale may be initiated.

In certain embodiments, during the harvesting process, the conveying system 34 and the baler 24 may be periodically activated to transfer the agricultural product 14 from the accumulator 26 to the baler 24 and to form the bale 46. For example, as the agricultural harvester 10 traverses a field, the agricultural product 14 may accumulate within the accumulator 26. After a selected duration, the conveying system 34 may be activated to transfer the agricultural product 14 from the accumulator 26 to the baler 24. For example, the conveying system 34 may move the agricultural product 14 toward the baler 24 at a significantly faster rate than the air-assisted conveying system 22 moves the agricultural product 14 into the accumulator 26. Concurrently with activation of the conveying system 34, the baler 24 may be activated to initiate the bale forming process, as described above. After another selected duration, the conveying system 34 and the baler 24 may be deactivated to enable the accumulator 26 to collect additional agricultural product 14. In certain embodiments, the conveying system 34 and the baler 24 may be activated four or five times to enable the bale 46 to reach the desired size. As previously discussed, once the bale reaches the desired size, the bale wrapping system 56 wraps the bale 46 with the bale wrap 58. Because the conveying system 34 and the baler 24 are periodically activated, the agricultural harvester 10 may utilize less energy during the harvesting process (e.g., as compared to continuously operating the conveying system and the baler).

In the illustrated embodiment, the agricultural harvester 10 includes a bale wrap assembly storage compartment 62 configured to store multiple bale wrap assemblies 64. In certain embodiments, each bale wrap assembly 64 includes a shaft and a bale wrap disposed about the shaft to form a roll of the bale wrap. However, in other embodiments, the shaft may be omitted, and the bale wrap may be arranged in a roll (e.g., with a hollow region at the center).

Furthermore, the agricultural harvester 10 (e.g., the bale wrapping system 56 of the agricultural harvester 10) includes a bale wrap feeding assembly configured to receive an active bale wrap assembly 66 from the bale wrap assembly storage compartment 62 and to feed the bale wrap 58 of the active bale wrap assembly 66 toward the bale 46 (e.g., toward the starter roller 60). The bale wrap feeding assembly includes one or more rollers and/or one or more belts driven by hydraulic motor(s). The roller(s) and/or the belt(s) are configured to engage the bale wrap and to drive the bale wrap toward the bale as the roller(s) and/or the belt(s) are driven by the hydraulic motor(s).

As discussed in detail below, in certain embodiments, at least one row unit 18 of the header 12 (e.g., each row unit 18 of the header 12) includes an outlet assembly configured to facilitate lateral movement of the row unit 18 along a chassis of the header 12. In such embodiments, the outlet assembly includes an input portion coupled to a frame of the row unit 18. The input portion includes an inlet configured to receive the agricultural product and an outlet configured to expel the agricultural product. The outlet assembly also includes an output portion having an inlet configured to receive the agricultural product from the outlet of the input portion and an outlet configured to direct the agricultural product into a respective duct 30 of the air-assisted conveying system 22. The output portion and the input portion are at least selectively coupled to one another and configured to at least selectively rotate relative to one another. As a result, the respective duct 30 is at least selectively rotatable relative to the row unit 18, thereby enabling the row unit 18 to move with respect to a lateral axis of the header 12. Therefore, the lateral spacing between row units 18 may be adjusted without removing and replacing the outlet assemblies, thereby substantially reducing the duration associated with adjusting the lateral spacing between the row units (e.g., as compared to a configuration in which the row units have non-rotating outlet assemblies particularly configured for a single row spacing, and changing the lateral spacing between the row units involves replacing the outlet assemblies with different outlet assemblies particularly configured for the different row spacing).

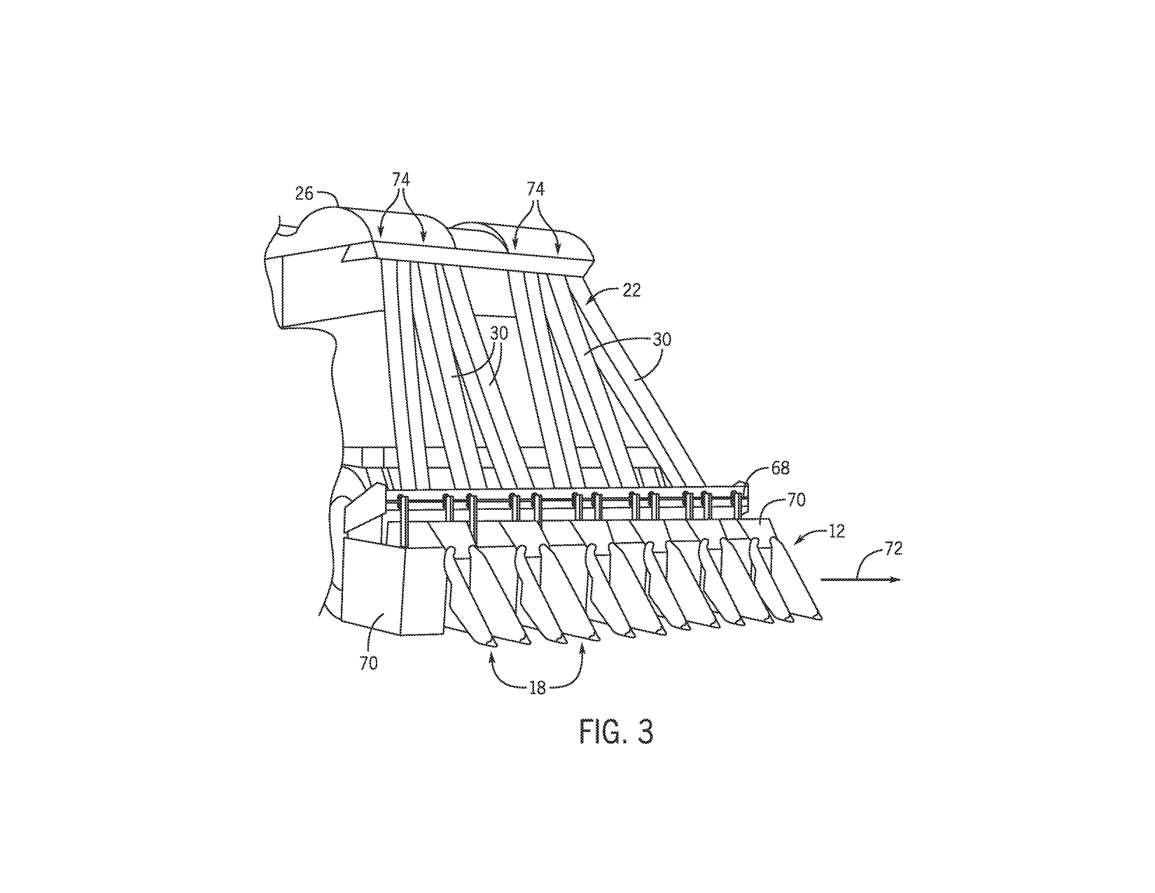

FIG. 3 is a perspective view of an embodiment of a header 12 that may be employed within the agricultural harvester of FIG. 1 and an embodiment of an air-assisted conveying system 22 that may be employed within the agricultural product transport assembly of FIG. 2. In the illustrated embodiment, the header 12 includes a chassis 68 configured to support multiple row units 18. In the illustrated embodiment, the header 12 includes six row units 18. However, in other embodiments, the header may include more or fewer row units (e.g., 1, 2, 3, 4, 5, 7, 8, 9, 10, or more). Each row unit 18 includes a frame 70 (e.g., chassis, housing, etc.) configured to support certain components of the row unit 18 (e.g., rotors, doffers, moistener columns, etc.). In addition, the frame 70 of each row unit 18 is movably coupled to the chassis 68 of the header 12 to enable lateral movement of the row unit 18 along the chassis 68 (e.g., movement of the row unit with respect to a lateral axis 72 of the header 12. Each frame 70 may be movably coupled to the chassis 68 via any suitable type(s) of coupling assembly/assemblies, such as roller/track assembly/assemblies, protrusion/groove assembly/assemblies, etc. The row units 18 may be moved with respect to the lateral axis 72 to position the row units 18 for a desired row spacing. For example, the row units 18 may be laterally moved along the chassis 68 to align the row units 18 with rows of crops having a 30-inch row spacing, with rows of crops having a 40-inch row spacing, etc. Once each row unit 18 is moved to a desired lateral position along the chassis 68, a locking mechanism may be engaged to block movement of the row unit 18.

In certain embodiments, each row unit 18 includes two rotors positioned on opposite sides of a central path through the row unit 18 or on the same side of the central path. Each rotor includes multiple spindles (e.g., barbed spindles) extending into the central path, and the spindles are configured to engage a crop (e.g., cotton plant) along a substantial portion of the height of the crop. During operation of the agricultural harvester, the central path of the row unit 18 is aligned with a row of crops. Accordingly, as the agricultural harvester traverses the field, the row unit 18 receives each crop of the row, and the spindles of the rotors engage the crop. The rotors are driven to rotate, such that engagement of the spindles with the crop separates the agricultural product (e.g., seed cotton) from the plant stalk (e.g., the crop after the agricultural product is removed). The agricultural product removed from the crop collects on the spindles, and the agricultural product is removed from the spindles by doffers. Each doffer directs the agricultural product to a respective conveying chamber, and airflow generated by the air-assisted conveying system 22 moves the agricultural product from the conveying chambers to the accumulator 26 via a duct 30 of the air-assisted conveying system 22. After the agricultural product is removed from the spindles of each rotor, the spindles pass through a moistener column assembly to remove buildup of crop liquids (e.g., sap, etc.) from the spindles. As the rotors continue to rotate, the spindles engage a subsequent crop at the central path, while the plant stalk remains attached to the ground.

In the illustrated embodiment, the air-assisted conveying system 22 includes six ducts 30, and each duct 30 extends from a respective row unit 18 to the accumulator 26. While the air-assisted conveying system 22 includes six ducts 30 in the illustrated embodiment, in other embodiments, the air-assisted conveying system may include more or fewer ducts (e.g., one duct for each row unit). Each duct 30 may be formed from any suitable material(s) (e.g., metal, plastic, composite, etc.). In the illustrated embodiment, each duct 30 has a first end pivotally coupled to the accumulator 26 via a respective pivotal connection 74. In addition, each duct 30 has a second end coupled to the respective row unit 18. The pivotal connection 74 between the first end of each duct 30 and the accumulator 26 enables the second end of the duct 30 to move with respect to the lateral axis 72. Each pivot connection 74 may include any suitable structure(s) to facilitate rotation of the respective duct 30 with respect to the accumulator 26, such as a flexible hose, a pivot joint, etc. Furthermore, in the illustrated embodiment, each duct 30 is configured to telescope to adjust a length of the duct 30 (e.g., the distance between the first end and the second end of the duct). For example, in certain embodiments, each duct includes two portions slidably engaged with one another to enable the duct to telescope.

In certain embodiments, each row unit 18 of the header 12 includes an outlet assembly configured to facilitate lateral movement of the row unit 18 along the chassis 68 of the header 12 (e.g., movement with respect to the lateral axis 72). In such embodiments, the outlet assembly includes an input portion coupled to the frame 70 of the row unit 18. The input portion includes an inlet configured to receive the agricultural product (e.g., from the conveying chambers of the row unit) and an outlet configured to expel the agricultural product. The outlet assembly also includes an output portion having an inlet configured to receive the agricultural product from the outlet of the input portion and an outlet configured to direct the agricultural product into a respective duct 30 of the air-assisted conveying system 22. The output portion and the input portion are at least selectively coupled to one another and configured to at least selectively rotate relative to one another. As a result, the respective duct 30 is at least selectively rotatable relative to the row unit 18, thereby enabling the row unit 18 to move with respect to the lateral axis 72 of the header 12. For example, as the row unit 18 moves with respect to the lateral axis 72, the outlet assembly enables the duct 30 to pivot with respect to the row unit 18, the pivot connection 74 enables the duct 30 to pivot with respect to the accumulator 26, and the telescoping capability of the duct 30 enables the length of the duct 30 to vary. Accordingly, the lateral spacing between row units may be adjusted without removing and replacing the outlet assemblies, thereby substantially reducing the duration associated with adjusting the lateral spacing between the row units (e.g., as compared to a configuration in which the row units have non-rotating outlet assemblies particularly configured for a single row spacing, and changing the lateral spacing between the row units involves replacing the outlet assemblies with different outlet assemblies particularly configured for the different row spacing). Furthermore, by using a single outlet assembly configuration for each row unit, the design and manufacturing costs of the agricultural harvester may be reduced (e.g., as compared to designing and manufacturing multiple outlet assemblies for the different lateral positions of the row units, which may vary for each row spacing).

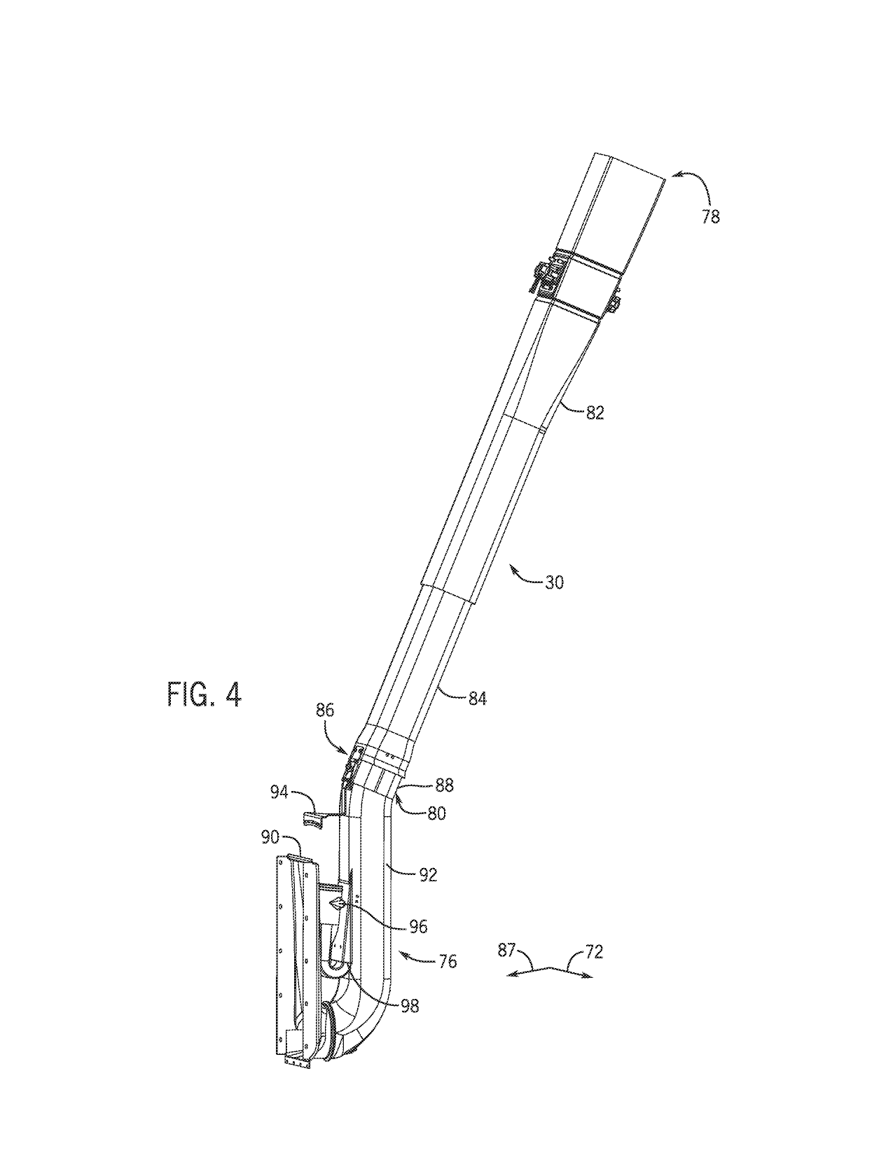

FIG. 4 is a perspective view of an embodiment of an outlet assembly 76 that may be employed within a row unit of the header of FIG. 3 and a duct 30 that may be employed within the air-assisted conveying system of FIG. 3. As previously discussed, the duct 30 is configured to telescope to adjust a length of the duct 30 (e.g., the distance between the first end 78 and the second end 80 of the duct 30). In the illustrated embodiment, the duct 30 includes a first portion 82 having the first end 78 and a second portion 84 having the second end 80. The first and second portions are slidably engaged with one another to enable the duct 30 to telescope. While the duct 30 includes two portions in the illustrated embodiment, in other embodiments, the duct may have three or more portions that are slidably engaged with one another to enable the duct to telescope. Furthermore, in certain embodiments, the duct may have any other suitable structure(s) configured to enable the duct to telescope (e.g., alone or in combination with the slidably engaged portions), such as an expandable hose, an accordion section, etc.

In the illustrated embodiment, the second end 80 of the duct 30 is coupled to the outlet assembly 76 of the row unit via a pivot joint 86. The pivot joint 86 enables the outlet assembly 76 to tilt forwardly and rearwardly (e.g., about an axis parallel to the lateral axis 72) to accommodate dimensional variations in longitudinal spacing between the row unit and the accumulator (e.g., with respect to a longitudinal axis 87). Furthermore, in the illustrated embodiment, the air-assisted conveying system includes a transition element 88 positioned at the interface between the duct 30 and the outlet assembly 76. The transition element 88 is configured to block agricultural product from flowing out of the interface between the duct 30 and the outlet assembly 76 and to enable the outlet assembly 76 to pivot relative to the duct 30 via the pivot joint 86. While the outlet assembly 76 is coupled to the duct 30 via the pivot joint 86 in the illustrated embodiment, in other embodiments, the outlet assembly may be non-pivotally coupled to the duct by any suitable type(s) of connection(s), such as a fastener connection, a welded connection, an adhesive connection, other suitable type(s) of connection(s), or a combination thereof. In such embodiments, the transition element may be omitted (e.g., in embodiments in which the duct overlaps a section of the output portion of the outlet assembly). Furthermore, as previously discussed, the first end 78 of the duct 30 is pivotally coupled to the accumulator. Accordingly, agricultural product may flow through the outlet assembly 76 of the row unit, through the duct 30, and into the accumulator.

As illustrated, the outlet assembly 76 includes an input portion 90 and an output portion 92. The input portion 90 is configured to couple to the frame of the row unit. In addition, the input portion 90 includes an inlet configured to receive agricultural product (e.g., from the conveying chambers of the row unit), and the input portion 90 includes an outlet configured to expel the agricultural product to the output portion 92. Furthermore, the output portion 92 includes an inlet configured to receive the agricultural product from the outlet of the input portion 90, and the output portion 92 includes an outlet configured to direct the agricultural product into the duct 30 of the air-assisted conveying system. As illustrated, the duct 30 is coupled to the output portion 92 of the outlet assembly 76. In certain embodiments, a section of the output portion 92 is disposed within the transition element 88, and a section of the transition element 88 is disposed within the duct 30. However, in other embodiments, a section of the transition element may be disposed within the output portion, and/or a section of the duct may be disposed within the transition element. Furthermore, as previously discussed, the transition element may be omitted. In such embodiments, a section of the output portion may be disposed within the duct.

The output portion 92 and the input portion 90 are at least selectively coupled to one another and configured to at least selectively rotate relative to one another. As a result, the duct 30 is at least selectively rotatable relative to the row unit, thereby enabling the row unit to move with respect to the lateral axis 72 of the header. Therefore, the lateral spacing between row units may be adjusted without removing and replacing the outlet assemblies, thereby substantially reducing the duration associated with adjusting the lateral spacing between the row units (e.g., as compared to a configuration in which the row units have non-rotating outlet assemblies particularly configured for a single row spacing, and changing the lateral spacing between the row units involves replacing the outlet assemblies with different outlet assemblies particularly configured for the different row spacing). In certain embodiments, the outlet assembly includes a V-band clamp configured to at least selectively couple the output portion and the input portion to one another and to at least selectively enable the output portion and the input portion to rotate relative to one another. Furthermore, in certain embodiments, a section of the output portion overlaps a section of the input portion, and the outlet assembly includes a hose clamp disposed about the section of the output portion. The hose clamp is configured to selectively couple the output portion and the input portion to one another and to selectively enable the output portion and the input portion to rotate relative to one another.

In the illustrated embodiment, the outlet assembly 76 includes a mounting bracket 94 coupled to the output portion 92 (e.g., via any suitable type(s) of connection(s), such as a fastener connection, an adhesive connection, etc.). The mounting bracket 94 is configured to couple to the frame of the row unit, thereby supporting the outlet assembly 76. In certain embodiments, to accommodate the pivoting movement of the output portion 92 relative to the input portion 90, the mounting bracket 94 includes one or more curved slots. One or more fasteners may be disposed through the curved slot(s) and coupled to the row unit frame, thereby movably coupling the output portion to the frame of the row unit. While movably coupling the mounting bracket to the row unit frame with fastener(s) is disclosed above, in certain embodiments, the mounting bracket may be movably coupled to the row unit frame by any other suitable type(s) of connection(s) (e.g., alone or in combination with the fastener connection). Furthermore, in certain embodiments, the mounting bracket may be omitted.

In the illustrated embodiment, the air-assisted conveying system includes an outlet nozzle 96 fluidly coupled to the conveying air source of the air-assisted conveying system. The outlet nozzle 96 may be fluidly coupled to the conveying air source by one or more fluid conduits (e.g., hose(s), tube(s), etc.). The outlet nozzle 96 is coupled to the output portion 92 of the outlet assembly 76 at an airflow inlet 98. The air output by the conveying air source flows through the outlet nozzle 96, through the airflow inlet 98, and through the output portion 92 of the outlet assembly 76. The air then flows through the duct 30 and into the accumulator. The airflow through the output portion 92 and the duct 30 establishes a low pressure region that draws air through the row unit and through the input portion 90 of the outlet assembly 76. The airflow through the row unit moves the agricultural product from the conveying chambers into the outlet assembly 76, and the airflow through the outlet assembly 76 and the duct 30 moves the agricultural product through the outlet assembly 76 and the duct 30 to the accumulator. While the outlet nozzle is coupled to the output portion of the outlet assembly in the illustrated embodiment, in other embodiments, the outlet nozzle may be coupled to the input portion of the outlet assembly or to another suitable portion of the row unit, or the outlet nozzle may be coupled to the duct.

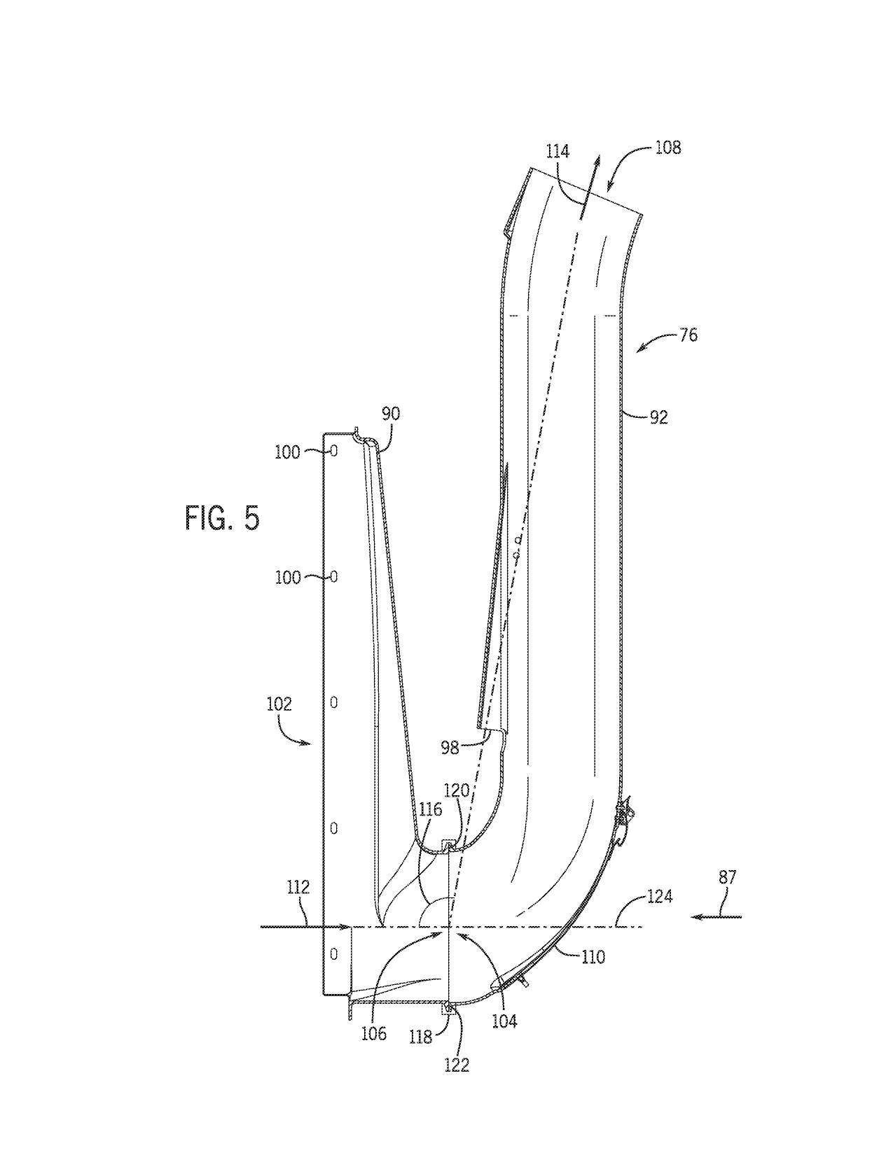

FIG. 5 is a cross-sectional view of the outlet assembly 76 of FIG. 4. As previously discussed, the input portion 90 of the outlet assembly 76 is configured to couple to the frame of the row unit. In the illustrated embodiment, the input portion 90 has apertures 100 configured to receive fasteners to facilitate coupling the input portion 90 to the frame of the row unit. While the input portion 90 is configured to be coupled to the frame of the row unit via a fastener connection in the illustrated embodiment, in other embodiments, the input portion may be coupled to the row unit frame via any suitable type(s) of connection(s) (e.g., alone or in combination with the fastener connection), such as an adhesive connection, a latched connection, a welded connection, other suitable type(s) of connection(s), or a combination thereof.

Furthermore, as previously discussed, the input portion 90 includes an inlet 102 configured to receive the agricultural product (e.g., from the conveying chambers of the row unit) and an outlet 104 configured to expel the agricultural product to the output portion 92 of the outlet assembly 76. In the illustrated embodiment, the input portion 90 includes angled walls configured to direct the agricultural product from the inlet 102 to the outlet 104. For example, the angled walls may extend toward the outlet 104 to facilitate flow of the agricultural product through the outlet 104. While the input portion 90 includes angled walls in the illustrated embodiment, in other embodiments, the input portion may have any other suitable shape (e.g., including flat wall(s), angled wall(s), curved wall(s), etc.).

In addition, the output portion 92 includes an inlet 106 configured to receive the agricultural product from the outlet 104 of the input portion 90. The output portion 92 also includes an outlet 108 configured to direct the agricultural product into the duct of the air-assisted conveying system. As previously discussed, the output portion 92 has an airflow inlet 98 configured to receive air from the conveying air source via an outlet nozzle. Furthermore, in the illustrated embodiment, the outlet assembly 76 includes a cleanout door 110 pivotally coupled to the output portion 92. The cleanout door 110 may be opened to facilitate removal of accumulated agricultural product within the outlet assembly 76. In certain embodiments, the cleanout door 110 may be selectively secured in the illustrated closed position with a latch. However, in other embodiments, the cleanout door may be selectively secured in the closed position by any other suitable type of connection (e.g., fastener connection, etc.). Furthermore, while the cleanout door is pivotally coupled to the output portion in the illustrated embodiment, in other embodiments, the cleanout door may be slidably or removably coupled to the output portion. In addition, in certain embodiments, a cleanout door may be coupled to the input portion (e.g., alone or in combination with the cleanout door coupled to the output portion). While the outlet assembly includes the cleanout door in the illustrated embodiment, in other embodiments the cleanout door may be omitted.

As illustrated, the agricultural product may flow along a flow path 112 through the inlet 102 of the input portion 90, and the agricultural product may flow along a flow path 114 through the outlet 108 of the output portion 92. In certain embodiments, an angle 116 between the flow path 112 through the inlet 102 of the input portion 90 and the flow path 114 through the outlet 108 of the output portion 92 may be 45 degrees to 135 degrees, 60 degrees to 120 degrees, 75 degrees to 105 degrees, or 85 degrees to 95 degrees. By way of further example, the angle 116 between the flow path 112 through the inlet 102 of the input portion 90 and the flow path 114 through the outlet 108 of the output portion 92 may be at least 45 degrees, at least 60 degrees, at least 75 degrees, or at least 90 degrees. However, in other embodiments, the angle 116 between the flow path 112 through the inlet 102 of the input portion 90 and the flow path 114 through the outlet 108 of the output portion 92 may be any other suitable angle.

In the illustrated embodiment, the outlet assembly 76 includes a V-band clamp 118 configured to at least selectively couple the output portion 92 and the input portion 90 to one another and to at least selectively enable the output portion 92 and the input portion 90 to rotate relative to one another. The V-band clamp 118 is configured to engage an annular protrusion 120 at the outlet 104 of the input portion 90, and the V-band clamp is configured to engage an annular protrusion 122 at the inlet 106 of the output portion 92, thereby coupling the output portion 92 and the input portion 90 to one another (e.g., blocking separation of the input portion 90 and the output portion 92 with respect to the longitudinal axis 87). In certain embodiments, the V-band clamp 118 may enable the output portion 92 and the input portion 90 to rotate relative to one another while the V-band clamp is fully secured to the input and output portions. However, in other embodiments, the V-band clamp may be loosened, without removing the V-band clamp from the input and output portions, to enable the output portion and the input portion to rotate relative to one another. In certain embodiments, while the V-band clamp is loosened, the V-band clamp may maintain the coupling between the input and output portions. Furthermore, in certain embodiments, the V-band clamp may uncouple the input and output portions while the V-band clamp is loosened. Accordingly, the V-band clamp 118 is configured to at least selectively couple the output portion 92 and the input portion 90 to one another and to at least selectively enable the output portion 92 and the input portion 90 to rotate relative to one another.

The output portion 92 and the input portion 90 are configured to at least selectively rotate relative to one another about a rotational axis 124. In certain embodiments, the rotational axis 124 may be generally parallel to the longitudinal axis 87 (e.g., within 5 degrees of the longitudinal axis 87, within 4 degrees of the longitudinal axis 87, within 3 degrees of the longitudinal axis 87, within 2 degrees of the longitudinal axis 87, within 1 degree of the longitudinal axis 87, within 0.5 degrees of the longitudinal axis 87). However, in other embodiments, the rotational axis may be oriented at any suitable angle relative to the longitudinal axis. Furthermore, in the illustrated embodiment, the outlet 104 of the input portion 90 and the inlet 106 of the output portion 92 have a circular shape to enable rotation of the input and output portions relative to one another at any angle about the axis 124. However, in other embodiments, the outlet of the input portion and/or the inlet of the output portion may have any other suitable shape (e.g., polygonal, star-shaped, etc.). In such embodiments, the input and output portions may be rotated relative to one another to one of a series of orientations that aligns the shape of the outlet of the input portion with the shape of the inlet of the output portion.

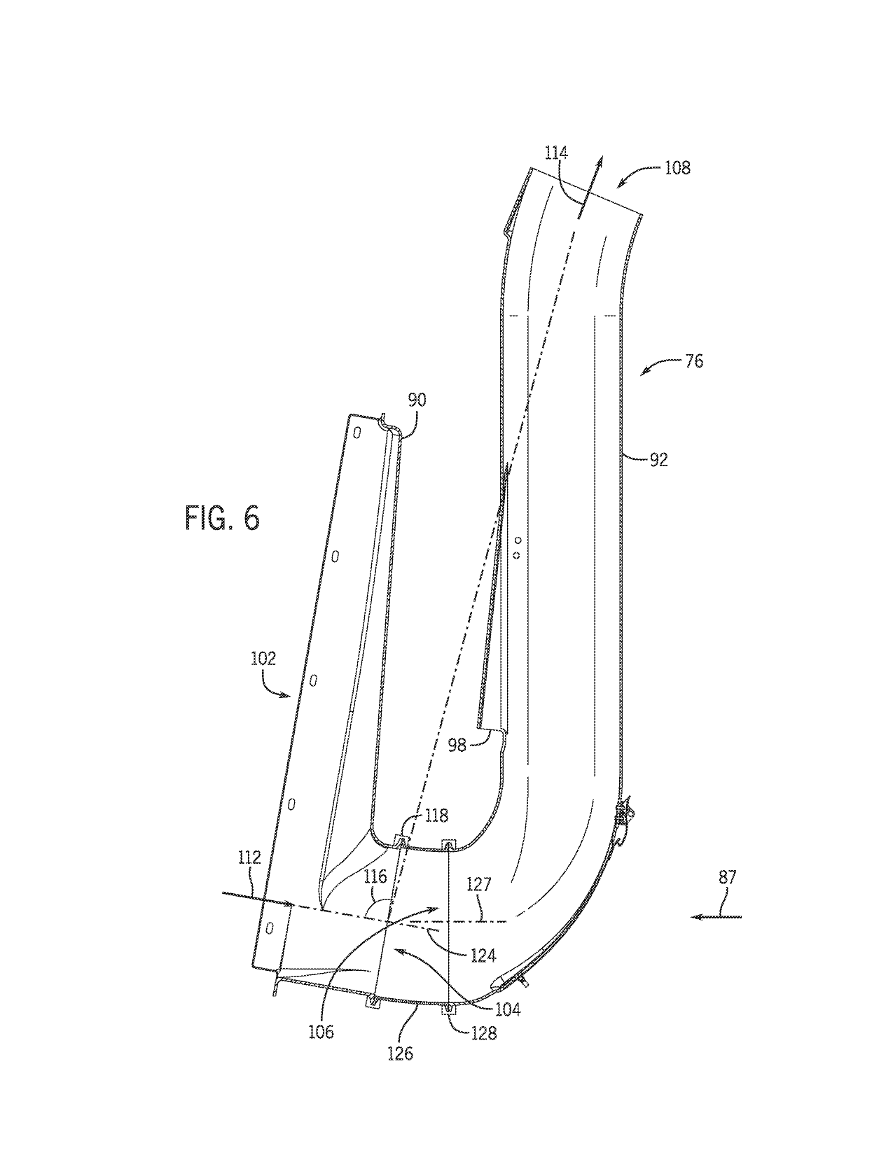

FIG. 6 is a cross-sectional view of the outlet assembly 76 of FIG. 4, including an adapter 126. As illustrated, the adapter 126 is disposed between the outlet 104 of the input portion 90 and the inlet 106 of the output portion 92. The adapter 126 is configured to orient the output portion 92 relative to the input portion 90, thereby establishing a desired angle 116 between the flow path 112 through the inlet 102 of the input portion 90 and the flow path 114 through the outlet 108 of the output portion 92. For example, certain row unit(s) (e.g., center row unit(s)) may be tilted rearwardly relative to the other row units (e.g., such that the front end of each tilted row unit is positioned above the front end of the other row units). Accordingly, the adapter 126 may be added to the outlet assembly 76 for each tilted row unit, thereby enabling the outlet assembly to accommodate the different orientation of the tilted row unit. The adapter 126 may be configured to change the angle 116 by an amount equal to the tilt angle of the tilted row unit (e.g., as compared to an outlet assembly 76 without the adapter 126), thereby maintaining the angle of the flow path 114 through the outlet 108 of the output portion 92. Accordingly, the orientation of the flow path 114 for a tilted row unit having the adapter 126 may be equal to the orientation of the flow path 114 for a non-tilted row unit without the adapter. As a result, a single input portion configuration and a single output portion configuration may be used for both non-tilted row units and tilted row units, which reduces design and manufacturing costs (e.g., as compared to designing and manufacturing different outlet assemblies for tilted and non-tilted row units).

In the illustrated embodiment, the V-band clamp 118 at least selectively couples the adapter 126 and the input portion 90 to one another and at least selectively enables the adapter 126 and the input portion 90 to rotate relative to one another about the rotational axis 124. Furthermore, a second V-band clamp 128 at least selectively couples the output portion 92 and the adapter 126 to one another and at least selectively enables the output portion 92 and the adapter 126 to rotate relative to one another about a second rotational axis 127. The second rotational axis 127 may be generally parallel to the longitudinal axis 87 (e.g., within 5 degrees of the longitudinal axis 87, within 4 degrees of the longitudinal axis 87, within 3 degrees of the longitudinal axis 87, within 2 degrees of the longitudinal axis 87, within 1 degree of the longitudinal axis 87, within 0.5 degrees of the longitudinal axis 87). However, in other embodiments, the second rotational axis may be oriented at any suitable angle relative to the longitudinal axis. Each end of the adapter 126 includes a respective annular protrusion configured to engage the respective V-band clamp. While the adapter is at least selectively coupled to the input portion by a V-band clamp in the illustrated embodiment, in other embodiments, the adapter may be at least selectively coupled to the input portion by another suitable connection, such as one of the connections disclosed below. Furthermore, while the adapter is at least selectively coupled to the output portion by a V-band clamp in the illustrated embodiment, in other embodiments, the adapter may be at least selectively coupled to the output portion by another suitable connection, such as one of the connections disclosed below. In addition, while the adapter is at least selectively rotatable relative to the input portion and the output portion in the illustrated embodiment, in certain embodiments, the adapter may be non-rotatable relative to one of the input portion or the output portion (e.g., via a suitable non-rotatable connection, such as a fastener connection, etc.). In the illustrated embodiment, the adapter 126 is rigid (e.g., formed from a rigid material, such as plastic, metal, composite material, etc.). However, in other embodiments, the adapter may be flexible (e.g., formed from a flexible material, such as rubber) to facilitate adjustment of the angle between the flow path through the inlet of the input portion and the flow path through the outlet of the output portion.

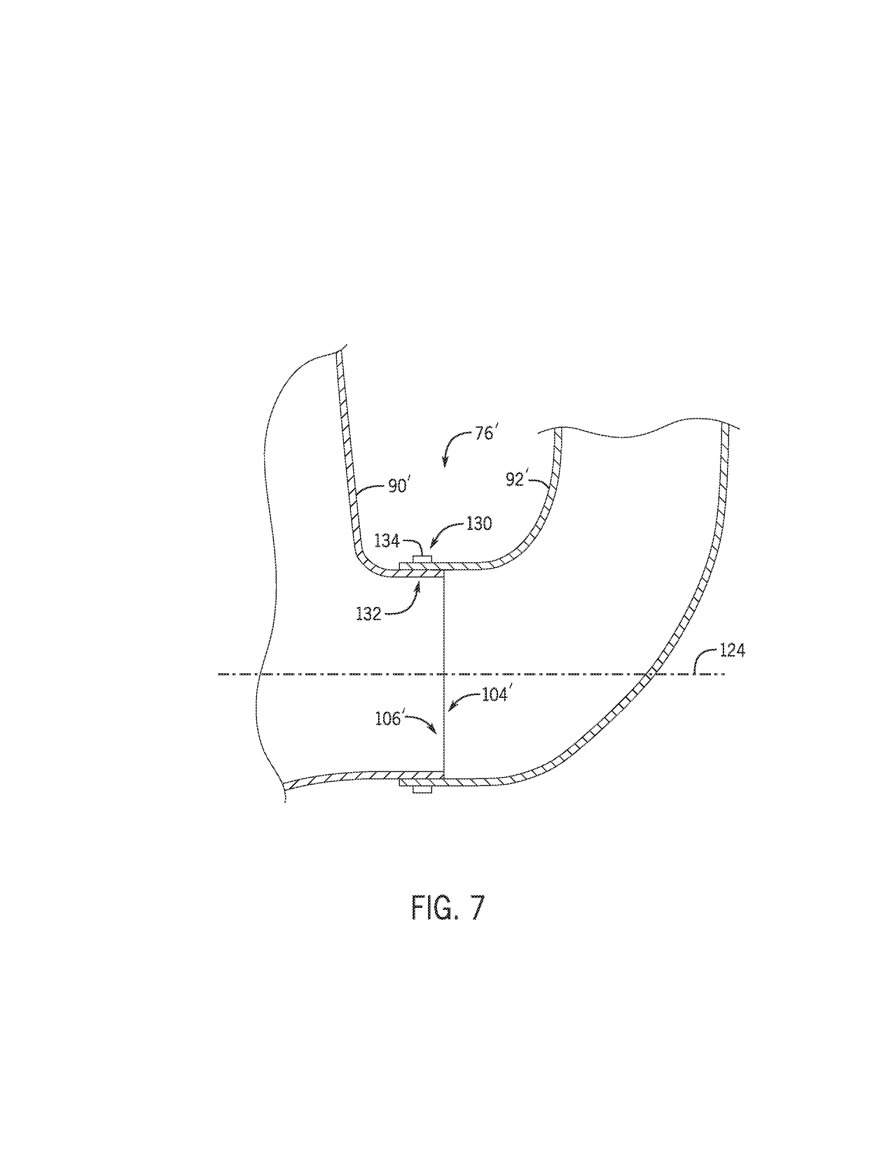

FIG. 7 is a cross-sectional view of a portion of another embodiment of an outlet assembly 76’ that may be employed within a row unit of the header of FIG. 3. As previously discussed, the inlet 106’ of the output portion 92’ is configured to receive the agricultural product from the outlet 104’ of the input portion 90’. In the illustrated embodiment, a section 130 of the output portion 92’ overlaps a section 132 of the input portion 90’. In addition, the outlet assembly 76’ includes a hose clamp 134 disposed about the section 130 of the output portion 92’. The hose clamp 134 is configured to selectively couple the output portion 92’ and the input portion 90’ to one another and to selectively enable the output portion 92’ and the input portion 90’ to rotate relative to one another. For example, while the hose clamp 134 is tightened, the hose clamp 134 couples the output portion 92’ and the input portion 90’ to one another and blocks rotation of the input and output portions relative to one another. However, to adjust the orientation of the output portion 92’ relative to the input portion 90’ (e.g., to move the respective row unit with respect to the lateral axis of the header), the hose clamp 134 is loosened. The loosened hose clamp 134 enables the output portion 92’ and the input portion 90’ to rotate relative to one another and uncouples the input and output portions. When the output portion 92’ is rotated about the rotational axis 124 to the desired orientation relative to the input portion 90’, the hose clamp 134 is tightened. While the section 130 of the output portion 92’ overlaps the section 132 of the input portion 90’ in the illustrated embodiment, in other embodiments, the section of the input portion may overlap the section of the output portion. In such embodiments, the hose clamp may be disposed about the section of the input portion.

While the connection between the input and output portions of the outlet assembly (e.g., including the hose clamp) is different than the connection between the input and output portions of the clamp assembly of FIG. 5 (e.g., including the V-clamp), the remainder of the outlet assembly is the same. Accordingly, all features and variations disclosed above with regard to the outlet assembly of FIG. 5 apply to the illustrated outlet assembly, except with regard to the connection between the input and output portions. Furthermore, an adapter, as disclosed above with reference to FIG. 6, may be included within the illustrated outlet assembly (e.g., the connection between at least one end of the adapter and the respective portion of the outlet assembly may include a hose clamp).

While the outlet assembly includes a V-band clamp or a hose clamp to at least selectively coupled the output portion and the input portion to one another and to at least selectively enable rotation of the input portion and the output portion relative to one another in the embodiments disclosed above, in certain embodiments, the outlet assembly may include another suitable connection to at least selectively couple the output portion and the input portion to one another and to at least selectively enable rotation of the input portion and the output portion relative to one another. For example, in certain embodiments, an inlet flange may be formed at the inlet of the output portion, and an outlet flange may be formed at the outlet of the input portion. Each flange may include multiple fastener apertures. Fasteners may be disposed through the apertures of each flange to selectively couple the input and output portions to one another and to block rotation of the output portion and the input portion relative to one another. Furthermore, the fasteners may be removed to facilitate rotation of the input and output portions relative to one another and to uncouple the input and output portions from one another. The orientation of the output portion relative to the input portion may be adjusted, and the fasteners may be reengaged with the apertures in the flanges. Accordingly, the flanged connection is configured to selectively couple the output portion and the input portion to one another and to selectively enable the output portion and the input portion to rotate relative to one another. In addition, in certain embodiments, the outlet assembly may include a bearing disposed between the input portion and the output portion. The bearing is configured to couple the input portion and the output portion to one another and to enable the input portion and the output portion to rotate relative to one another.

In the embodiments disclosed above, the output portion and the duct are separate elements. However, in certain embodiments, the output portion may be integrally formed with (e.g., integrally coupled to) the duct (e.g., the second portion of the duct). Furthermore, in the embodiments disclosed above, the input portion and the frame of the row unit are separate elements. However, in certain embodiments, the input portion may be integrally formed with (e.g., integrally coupled to) the frame of the row unit.

While only certain features have been illustrated and described herein, many modifications and changes will occur to those skilled in the art. It is, therefore, to be understood that the appended claims are intended to cover all such modifications and changes as fall within the true spirit of the disclosure.

The techniques presented and claimed herein are referenced and applied to material objects and concrete examples of a practical nature that demonstrably improve the present technical field and, as such, are not abstract, intangible or purely theoretical. Further, if any claims appended to the end of this specification contain one or more elements designated as “means for [perform]ing [a function]…” or “step for [perform]ing [a function]…”, it is intended that such elements are to be interpreted under 35 U.S.C. 112(f). However, for any claims containing elements designated in any other manner, it is intended that such elements are not to be interpreted under 35 U.S.C. 112(f).

1. An outlet assembly for a row unit of an agricultural harvester, comprising:
an input portion configured to be coupled to a frame of the row unit, wherein the input portion comprises:
an inlet configured to receive agricultural product; and
an outlet configured to expel the agricultural product; and
an output portion, comprising:
an inlet configured to receive the agricultural product from the outlet of the input portion; and
an outlet configured to direct the agricultural product into a duct of an air-assisted conveying system;
wherein the output portion and the input portion are at least selectively coupled to one another and configured to at least selectively rotate relative to one another.

2. The outlet assembly of claim 1, comprising a V-band clamp configured to at least selectively couple the output portion and the input portion to one another and to at least selectively enable the output portion and the input portion to rotate relative to one another.

3. The outlet assembly of claim 1, wherein a section of the output portion overlaps a section of the input portion.

4. The outlet assembly of claim 3, comprising a hose clamp disposed about the section of the output portion, wherein the hose clamp is configured to selectively couple the output portion and the input portion to one another and to selectively enable the output portion and the input portion to rotate relative to one another.

5. The outlet assembly of claim 1, wherein an angle between a flow path through the inlet of the input portion and a flow path through the outlet of the output portion is at least 45 degrees.

6. The outlet assembly of claim 1, comprising an adapter disposed between the inlet of the output portion and the outlet of the input portion, wherein the adapter is configured to orient the output portion relative to the input portion.

7. A row unit for an agricultural harvester, comprising:
a frame configured to be movably coupled to a chassis of a header of the agricultural harvester to enable lateral movement of the row unit along the chassis; and
an outlet assembly, comprising:
an input portion coupled to the frame, wherein the input portion comprises:
an inlet configured to receive agricultural product; and
an outlet configured to expel the agricultural product; and
an output portion, comprising:
an inlet configured to receive the agricultural product from the outlet of the input portion; and
an outlet configured to direct the agricultural product into a duct of an air-assisted conveying system;
wherein the output portion and the input portion are at least selectively coupled to one another, and the output portion and the input portion are configured to at least selectively rotate relative to one another to facilitate the lateral movement of the row unit along the chassis.

8. The row unit of claim 7, wherein the outlet assembly comprises a V-band clamp configured to at least selectively couple the output portion and the input portion to one another and to at least selectively enable the output portion and the input portion to rotate relative to one another.

9. The row unit of claim 7, wherein a section of the output portion overlaps a section of the input portion.

10. The row unit of claim 9, wherein the outlet assembly comprises a hose clamp disposed about the section of the output portion, and the hose clamp is configured to selectively couple the output portion and the input portion to one another and to selectively enable the output portion and the input portion to rotate relative to one another.

11. The row unit of claim 7, wherein an angle between a flow path through the inlet of the input portion and a flow path through the outlet of the output portion is at least 45 degrees.

12. The row unit of claim 7, wherein the outlet assembly comprises an adapter disposed between the inlet of the output portion and the outlet of the input portion, and the adapter is configured to orient the output portion relative to the input portion.

13. An agricultural harvester, comprising:
an air assisted conveying system comprising a duct configured to provide agricultural product to an accumulator of the agricultural harvester; and
a header, comprising:
a chassis; and
a row unit, comprising:
a frame movably coupled to the chassis to enable lateral movement of the row unit along the chassis; and
an outlet assembly, comprising:
an input portion coupled to the frame, wherein the input portion comprises:
an inlet configured to receive the agricultural product; and
an outlet configured to expel the agricultural product; and
an output portion, comprising:
an inlet configured to receive the agricultural product from the outlet of the input portion; and
an outlet configured to direct the agricultural product into the duct of the air-assisted conveying system;
wherein the output portion and the input portion are at least selectively coupled to one another, and the output portion and the input portion are configured to at least selectively rotate relative to one another to facilitate the lateral movement of the row unit along the chassis.

14. The agricultural harvester of claim 13, wherein the outlet assembly comprises a V-band clamp configured to at least selectively couple the output portion and the input portion to one another and to at least selectively enable the output portion and the input portion to rotate relative to one another.

15. The agricultural harvester of claim 13, wherein a section of the output portion overlaps a section of the input portion.

16. The agricultural harvester of claim 15, wherein the outlet assembly comprises a hose clamp disposed about the section of the output portion, and the hose clamp is configured to selectively couple the output portion and the input portion to one another and to selectively enable the output portion and the input portion to rotate relative to one another.

17. The agricultural harvester of claim 13, wherein an angle between a flow path through the inlet of the input portion and a flow path through the outlet of the output portion is at least 45 degrees.

18. The agricultural harvester of claim 13, wherein the outlet assembly comprises an adapter disposed between the inlet of the output portion and the outlet of the input portion, and the adapter is configured to orient the output portion relative to the input portion.

19. The agricultural harvester of claim 13, wherein the duct is configured to telescope to adjust a length of the duct.

20. The agricultural harvester of claim 13, wherein the duct is configured to be pivotally coupled to the accumulator.
